(19) United States
(12) Patent Application Publication
(10) Pub. No.: US 2025/0178549 A1
(43) Pub. Date: Jun. 5, 2025

(54) VEHICLE SEAT

(71) Applicant: GM Global Technology Operations LLC, Detroit, MI (US)

(72) Inventors: Minsu Lee, Gyeonggi-do (KR); Jongseong Choi, Incheon (KR); Dongwon Kim, Incheon (KR); Heewon Lee, Seoul (KR); Jongsuk An, Incheon (KR)

(73) Assignee: GM Global Technology Operations LLC, Detroit, MI (US)

(21) Appl. No.: 18/528,280

(22) Filed: Dec. 4, 2023

(51) Int. Cl. B60R 16/03; B60N 2/64; B60Q 3/50; B60Q 3/70; B60R 7/04; H02J 7/00; H02J 50/10

(52) U.S. Cl. CPC B60R 16/03; B60N 2/64; B60Q 3/70; B60R 7/043; H02J 7/0044; H02J 50/10; B60Q 3/50

(57) ABSTRACT

A vehicle seat includes a seat bottom and a seatback coupled to the seat bottom. The seatback includes a front portion configured to oppose a vehicle occupant located on the seat bottom, a rear portion disposed on an opposite side of the seatback than the front portion and including a pocket, and a wireless charging module disposed between the front portion and the rear portion and configured to wirelessly charge a user device located in the pocket.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a vehicle seat configured to wirelessly charge a user device.

Vehicles typically include numerous storage compartments to contain items during use. For example, conventional vehicles typically include a glovebox located in an instrument panel of a vehicle and movable between a closed state and an open state. Such gloveboxes were originally designed to store driving gloves, which were worn to keep a driver's hands clean when operating the vehicle. With modern vehicles, such driving gloves are no longer needed but almost every vehicle still has a glovebox, as gloveboxes provide a convenient way to store useful items such as a tire gauge, change, and vehicle instruction manuals to name a few.

In a similar vein, modern vehicles often still include map pockets located on a rear side of a vehicle seat even though most vehicle navigation is accomplished by using a vehicle's navigation system and/or by using a map feature of a cellular phone or tablet. Map pockets, while unlikely to store maps as originally intended, are still incorporated in vehicles and may be used to store useful items such as a book or tissues for use by occupants traveling in a rear seat of a vehicle.

While map pockets have been repurposed in a similar fashion as gloveboxes, map pockets are typically limited in size and are therefore not capable of accommodating large or bulky items. Rather, map pockets are only suitable for accommodating slender and somewhat narrow objects. Accordingly, map pockets are limited in terms of the types and sizes of objects that can be contained therein and, as a result, are underutilized.

### SUMMARY

In one configuration, a vehicle seat includes a seat bottom and a seatback coupled to the seat bottom. The seatback includes a front portion configured to oppose a vehicle occupant located on the seat bottom, a rear portion disposed on an opposite side of the seatback than the front portion and including a pocket, and a wireless charging module disposed between the front portion and the rear portion and configured to wirelessly charge a user device located in the pocket.

The vehicle seat may include one or more of the following optional features. For example, the pocket may be configured to move between an upper position and a lower position relative to and along the rear portion. Additionally or alternatively, the pocket may be configured to move along a longitudinal axis between a first position and second position relative to the rear portion.

The pocket may include at least one illumination device configured to provide notification that the user device is being charged by the wireless charging module. The illumination device may be configured to change color to indicate a full charge of the user device.

In one configuration, the rear portion may include a Universal Serial Bus (USB) port configured to charge the user device through wired charging. Further, the user device may be a cellular phone or a tablet. A vehicle may incorporate the vehicle seat.

In another configuration, a vehicle seat includes a seat bottom and a seatback coupled to the seat bottom. The seatback includes a front portion configured to oppose a vehicle occupant located on the seat bottom and a rear portion disposed on an opposite side of the seatback than the front portion and including a pocket movable relative to the rear portion between a first position and a second position, the rear portion configured to receive and charge a user device when the pocket is in the first position and configured to receive and charge the user device when the pocket is in the second position.

The vehicle seat may include one or more of the following optional features. For example, the pocket may be moveable along a longitudinal axis between the first position and the second position. Additionally or alternatively, the pocket may move in a direction away from the seat bottom when moved from the first position to the second position.

The pocket may include at least one illumination device configured to provide notification that the user device is being charged. The illumination device may be configured to change color to indicate a full charge of the user device.

In one configuration, the rear portion may include a Universal Serial Bus (USB) port configured to charge the user device through wired charging. Further, the user device may be a cellular phone or a tablet. A vehicle may incorporate the vehicle seat.

In yet another configuration, a vehicle includes a vehicle seat including a seat bottom and a seatback coupled to the seat bottom. The seatback includes a front portion configured to oppose a vehicle occupant located on the seat bottom, a rear portion disposed on an opposite side of the seatback than the front portion, a pocket located on the rear portion and moveable relative to the rear portion between a first position and a second position, and a wireless charging module disposed between the front portion and the rear portion and configured to wirelessly charge a user device located in the pocket, the wireless charging module configured to charge the user device when the pocket is in the first position and configured to charge the user device when the pocket is in the second position.

The vehicle may include one or more of the following optional features. For example, the pocket may be moveable along a longitudinal axis between the first position and the second position. Additionally or alternatively, the pocket may move in a direction away from the seat bottom when moved from the first position to the second position.

In one configuration, the user device may be a cellular phone or a tablet.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to the present disclosure;

FIG. 2A is a perspective view of an interior of the vehicle of FIG. 1 having a vehicle seat including a wireless charging pocket in an upper position;

FIG. 2B is a perspective view of an interior of the vehicle of FIG. 1 having a vehicle seat including a wireless charging pocket in a lower position;

FIG. 3A is a rear plan view of the vehicle seat of FIGS. 2A and 2B having the wireless charging pocket including a user device in a first configuration;

FIG. 3B is a rear plan view of the vehicle seat of FIGS. 2A and 2B having the wireless charging pocket including the user device in a second configuration;

FIG. 4 is a cross-sectional view of the vehicle seat according to one aspect of the present disclosure;

FIG. 5 is a partial rear perspective view of the wireless charging pocket removed from the vehicle seat according to one aspect of the present disclosure;

FIG. 6 is a breakaway interior view of the vehicle seat according to one aspect of the present disclosure;

FIG. 7 is a close-up view of a back panel of the vehicle seat and the wireless charging pocket according to one aspect of the present disclosure;

FIG. 8 is rear plan view of a vehicle seat having a wireless charging pocket according to another aspect of the present disclosure;

FIG. 9 is a rear plan view of a vehicle seat having a wireless charging pocket according to another aspect of the present disclosure; and

FIG. 10 is a close-up rear plan view of the wireless charging pocket of FIG. 9.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to” “directly connected to” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below; the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., .EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube). LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

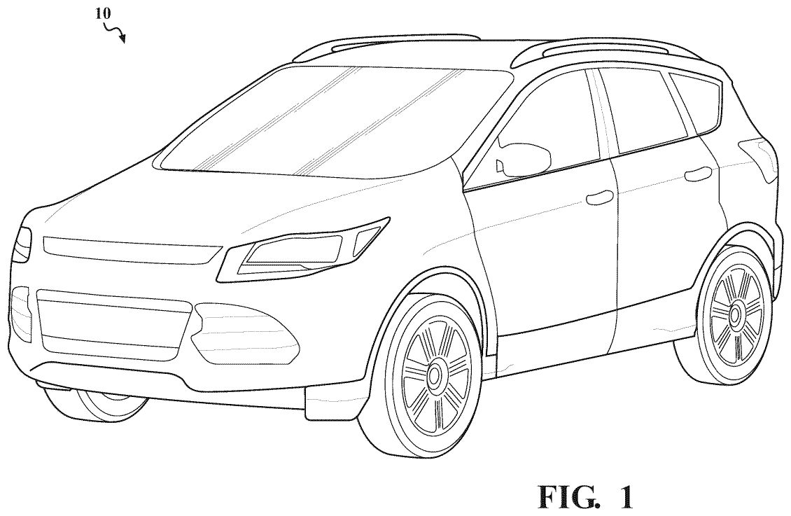

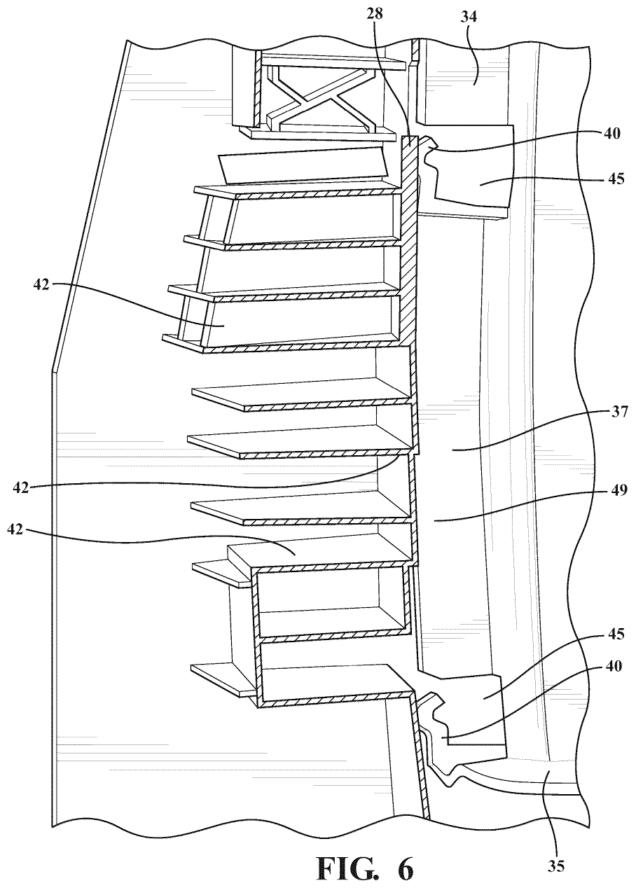

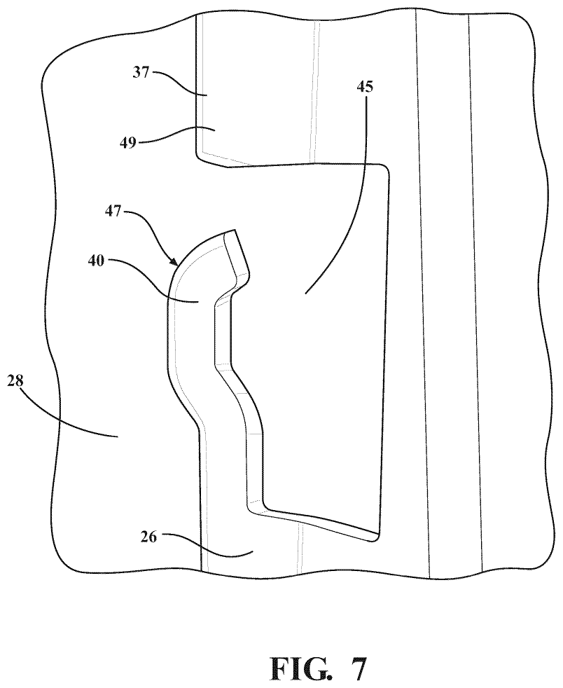

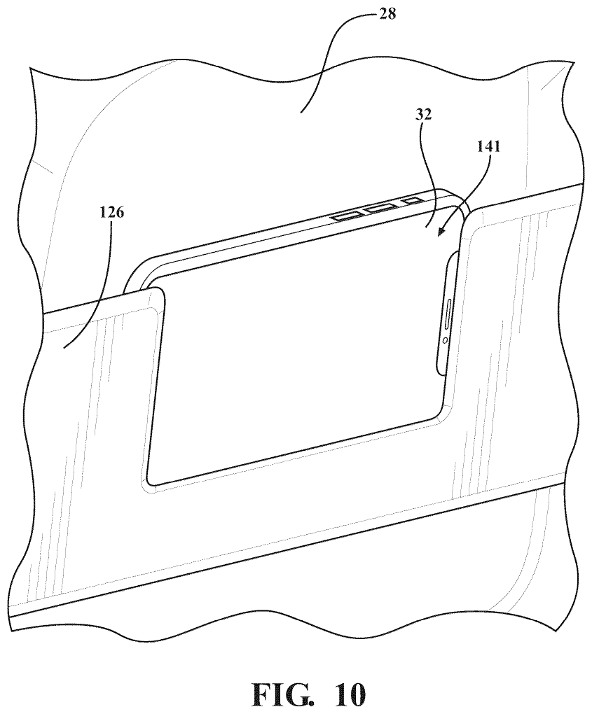

Referring to FIGS. 1-10, a vehicle seat 14 includes a seat bottom 16 configured to allow a seated vehicle passenger thereon and a seatback 18 coupled to the seat bottom 16. The seatback 18 also includes a wireless charging pocket 26. The vehicle seat 14 may be incorporated into a vehicle 10, as illustrated in FIG. 1. The vehicle 10 may be an electric vehicle 10 (EV) and may include autonomous or semi-autonomous capabilities. Alternatively, the vehicle 10 may include internal combustion engine (ICE) components and capabilities. Additionally, the vehicle 10 may be a hybrid vehicle 10 incorporating both EV and ICE components and capabilities.

The vehicle 10 includes a vehicle interior 12 configured to allow a vehicle driver, a vehicle front passenger, and/or one or more additional vehicle occupants to be seated therein. Additionally, the vehicle interior 12 includes one or more vehicle seats 14 configured to seat the vehicle driver or other occupants thereon. For example, the vehicle interior 12 may include two bucket-type vehicle seats 14 in a front row near a vehicle dashboard to accommodate the vehicle driver and a front passenger along with a bench-type vehicle seat to accommodate one or more rear vehicle occupants. Some vehicles 10 may also include an additional row or rows of bucket-type vehicle seats disposed within the interior 12.

While the vehicle seat 14 may be various types of vehicle seats, the vehicle seat 14 described below is a bucket-type vehicle seat disposed in the front row of the vehicle interior 12. The vehicle seat 14 includes the seat bottom 16 configured to allow the vehicle driver or front passenger to sit thereon and the seatback 18 generally configured to support a back of the vehicle driver or front passenger while seated on the seat bottom 16. The vehicle seat 14 may also include a headrest 20 coupled to and extending from the seatback 18.

The seat bottom 16 is disposed generally perpendicular with a floor of the vehicle 10 and may be movable between fore and aft positions. Additionally, the seat bottom 16 may house one or more electronic components to provide power to the vehicle seat 14. The electronic components may be configured to power features of the vehicle seat 14 including, but not limited to, seat bottom 16 and/or seatback 18 adjustment, vehicle seat heating, and charging capabilities. Moreover, the electronic components may have their own power source or may use power from a vehicle battery (neither shown).

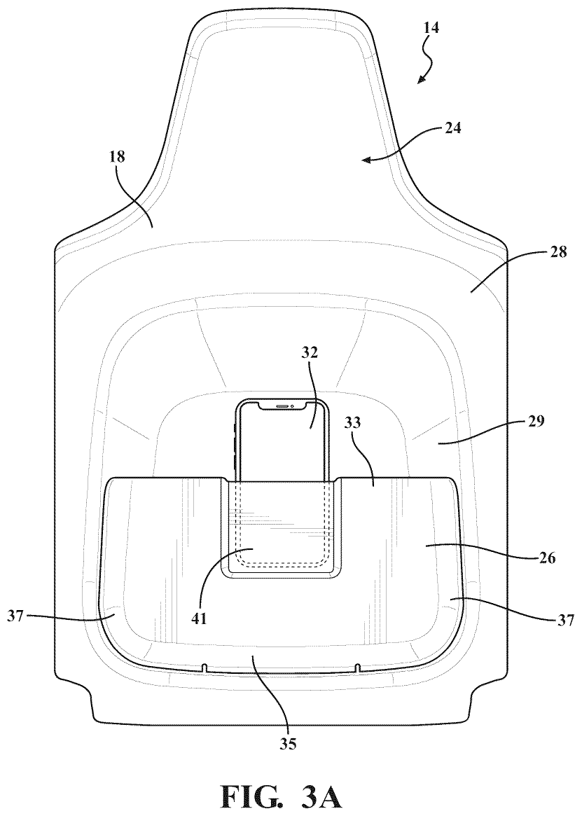

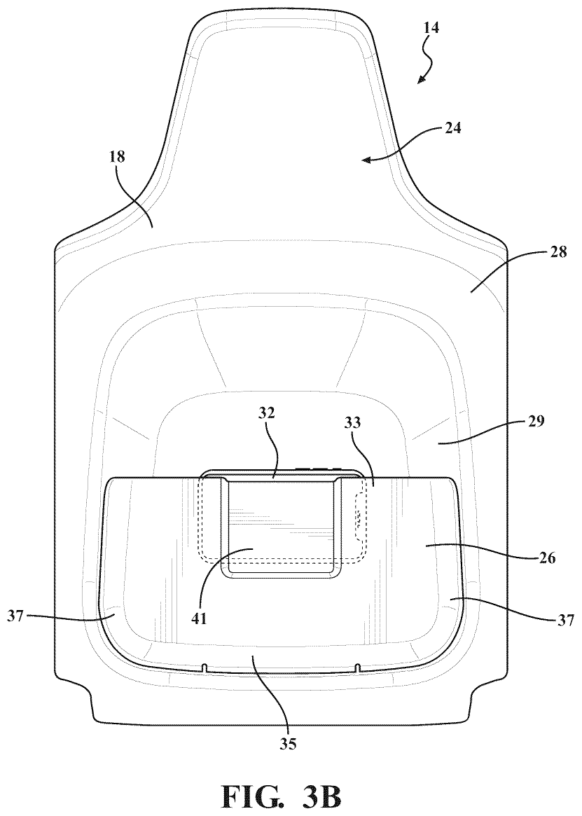

The seatback 18 extends from the seat bottom 16 and includes a front portion 22 configured to engage a back of the vehicle driver or front passenger seated on the seat bottom 16 and a rear portion 24 located on an opposite side of the seatback 18 than the front portion 22. More specifically, the seatback 18 is hingedly coupled with the seat bottom 16 such that the seatback 18 may be movable relative to the seat bottom 16. The rear portion 24 of the seatback 18 is disposed opposite the front portion 22 and includes the wireless charging pocket 26. More specifically, the back portion 24 includes a back panel 28 having a surface that is coupled to the wireless charging pocket 26. In the example shown in FIGS. 3A and 3B, the back panel 28 has a concave portion 29 to allow for easy access to and additional storage room for the wireless charging pocket 26. However, it is also contemplated that the back panel 28 may be generally flat to allow electronic components to be disposed within or coupled to the back panel 28 without affecting additional components of the vehicle seat 14. Additionally, the back panel 28 may include one or more ribs 42 configured to provide strength to the back panel 28.

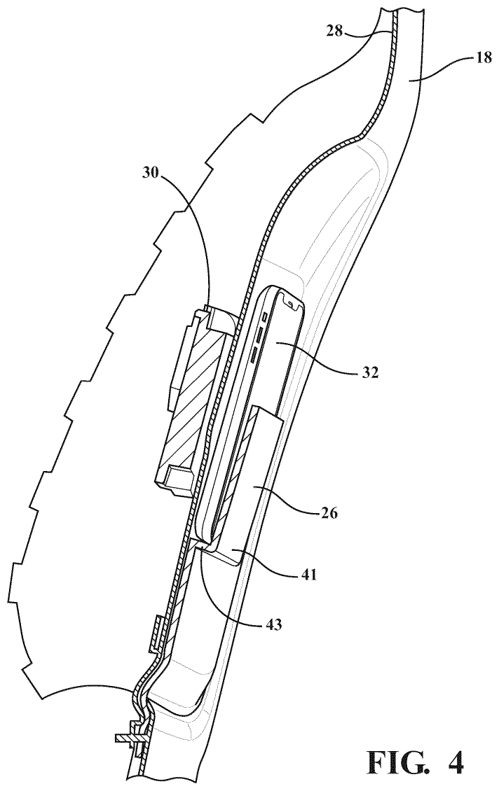

As best illustrated in FIG. 4, the seatback 18 includes a wireless charging module 30 disposed between the front portion 22 and the rear portion 24, and coupled to the back panel 28. More specifically, the wireless charging module 30 may be adjacent to and/or in contact with the back panel 28. The wireless charging module 30 is configured to wirelessly charge a user device 32 placed in the wireless charging pocket 26. In some examples, the wireless charging module 30 is configured to use magnetic induction, using an electromagnetic field to transfer energy between the wireless charging module 30 and the user device 32. Additionally, the wireless charging module 30 may be coupled to and receive power from an electronic power source configured to operate other functions of the vehicle seat 14. While the wireless charging module 30 is described as being coupled to the electronic power source of the vehicle seat 14, the wireless charging module 30 may include its own power source and/or may use the vehicle battery or other power source within the vehicle 10.

The user device 32 may be any handheld device that includes a display configured to display words or images to the vehicle occupant. In some examples, the user device 32 may be a cellular phone such as a smartphone having a touchscreen. In other examples, the user device 32 may be a tablet, which generally has a larger screen size than a cellular phone. Additionally, the user device 32 is a re-chargeable device such that the user device 32 is able to have its electrical energy restored by connection to a power supply, such as the wireless charging module 30. Finally, while the user device 32 is described as including a touchscreen, any user device 32 capable of having its electrical energy restored by the charging module 30—with or without a touchscreen-could be used in conjunction with the wireless charging pocket 26.

Referring now to the example shown in FIGS. 3A-4, the rear portion 24 of the seatback 18 includes the wireless charging pocket 26. The wireless charging pocket 26 may be a pocket having a generally rectangular shape including a top portion 33, a bottom portion 35, and two side portions 37 disposed opposite one another. The side portions 37 and the bottom portion 35 may include one or more coupling mechanisms to secure the wireless charging pocket 26 to the back panel 28. Additionally, the top portion 33 is configured to be movable and is not directly coupled to the back panel 28 to allow the user device 32 to be placed therein. Namely, the top portion 33 defines an opening to the wireless charging pocket 26 that initially receives the user device 32 when the user device 32 is inserted into the pocket 26, as shown in FIGS. 3A and 3B.

Additionally, the wireless charging pocket 26 is configured to be sized and shaped to accommodate any user device 32 including, but not limited to, a cellular phone or tablet. To accommodate the user device 32 of any size, the wireless charging pocket 26 may be made of a flexible, yet strong material. For example, the wireless charging pocket 26 may have the elasticity to be flexible enough to allow for any size user device 32 to be secured within the wireless charging pocket 26 without other mechanical securing mechanisms. Additionally, the wireless charging pocket 26 may have the strength to consistently hold the user device 32 against the back panel to facilitate charging of the user device 32.

Moreover, the flexibility of the wireless charging pocket 26 allows the user device 32 to be stored and charged within the wireless charging pocket 26 in various configurations. For example, the user device 32 may be placed within the wireless charging pocket 26 in a first configuration such as a vertical configuration, as illustrated in FIG. 3A. Further, the user device 32 may be placed within the wireless charging pocket 26 in a second configuration such as a horizontal configuration illustrated in FIG. 3B. In each of the configurations shown in FIGS. 3A and 3B, the user device 32 is charged by the wireless charging module 30. Moreover, the user device 32 may be placed in any configuration between the vertical configuration and the horizontal configuration to be charged. As such, when the vehicle occupant desires for the user device 32 to be charged, the user may simply place the user device 32 into the wireless charging pocket 26 in any configuration.

Additionally, the wireless charging pocket 26 is configured to allow at least a portion of the display of the user device 32 to be viewed by the vehicle occupant. To facilitate viewing of the user device 32 while charging within the wireless charging pocket 26, the wireless charging pocket 26 may include a protruding portion 41, as best shown in FIGS. 3A-4. The protruding portion 41 may be shaped and sized to fit the user device 32 in the vertical configuration and includes a ledge 43, which allows the user device 32 to be placed thereon to prevent further downward movement of the user device 32 within the wireless charging pocket 26. As such, when the vehicle occupant places the user device 32 within the wireless charging pocket 26 in the vertical configuration, the user device 32 rests on the ledge 43 such that at least a portion of the display is visible to the vehicle occupant above the wireless charging pocket 26. The protruding portion 41 may be comprised of the same material as the remainder of the wireless charging pocket 26 such that the user device 32 is secured by the wireless charging pocket 26 within the protruding portion 41 and configured to be charged therein. In some examples, the wireless charging pocket 26 may include more than one protruding portion 41 configured to allow visibility to the user device 32 while charging various sizes and/or configurations of user devices 32.

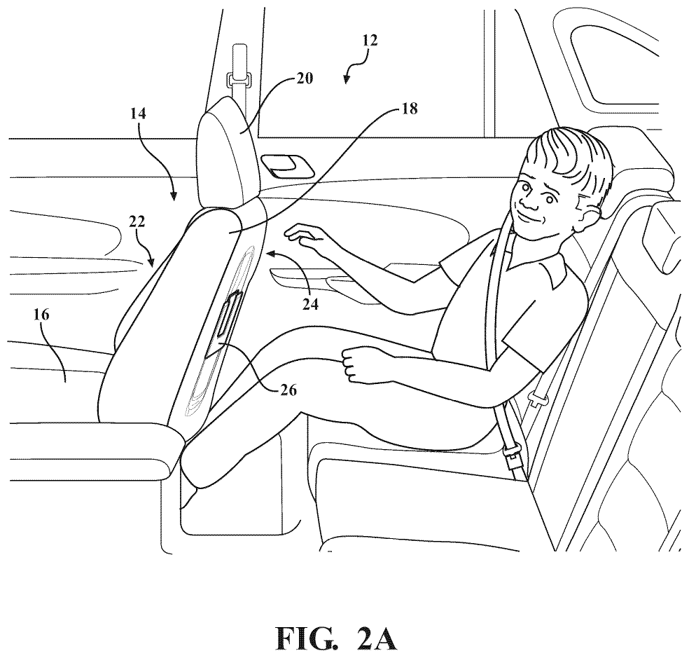

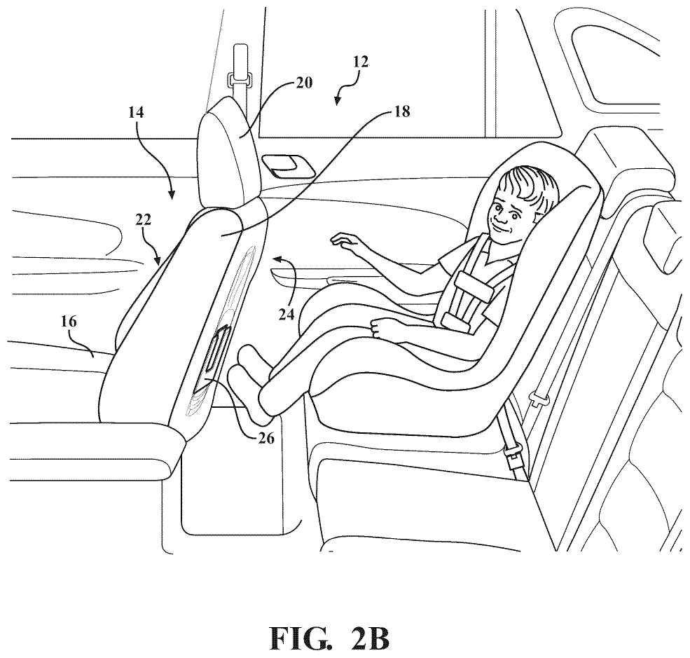

Additionally, the wireless charging pocket 26 is configured to move between an upper position (see FIG. 2A) and a lower position (see FIG. 2B) along the rear portion of the vehicle seat 14. More specifically, the wireless charging pocket 26 is configured to move vertically along a longitudinal axis between the lower position disposed closer to the seat bottom 16 along the seat back panel 28 and the upper position disposed further from the seat bottom 16 than the lower position along the seat back panel 28 and towards the headrest 20. Additionally, the wireless charging module 30 is configured to charge the user device 32 when the wireless charging pocket 26 is in the upper position, in the lower position, and between the upper position and the lower position. The upper and lower positions are configured to provide flexibility of viewing angle of the user device 32 to the vehicle occupants. As such, the upper and lower positions allow vehicle occupants of all ages and sizes to comfortably view the display of the user device 32 during wireless charging of the user device 32.

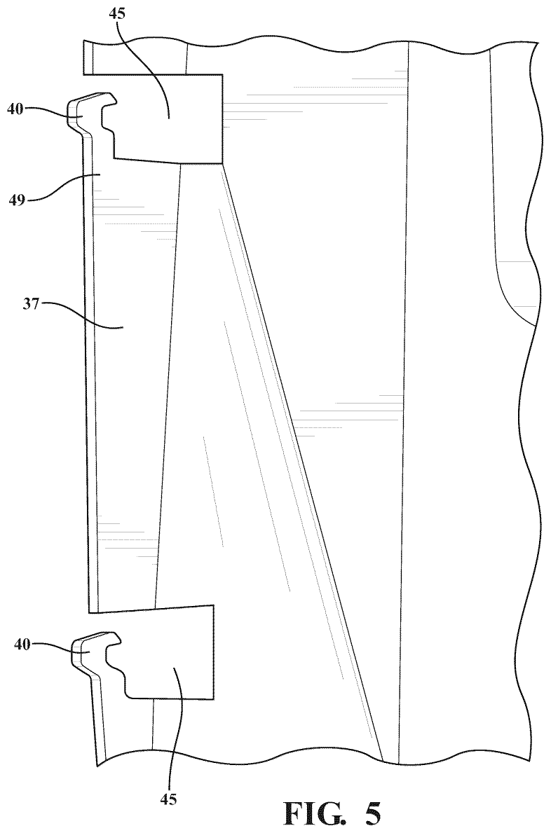

To facilitate movement of the wireless charging pocket 26 between the upper position (see FIG. 2A) and the lower position (see FIG. 2B), the wireless charging pocket 26 includes a back panel engaging portion 49 disposed along the side portions 37 and the bottom portion 35. The back panel engaging portion 49 is disposed generally parallel with the back panel 28 and is configured to allow the wireless charging pocket 26 to slide along the back panel 28 between the upper position and the lower position. The back panel engaging portion 49 and, more specifically, the back panel engaging portion 49 disposed along either side portion 37 of the wireless charging pocket 26 may include one or more hooks 40 disposed on opposite sides of the wireless charging pocket 26. In the example shown, the back panel 28 engaging portion 49 includes two hooks 40 located on each side portion, however, it is contemplated that only one hook 40 or more than two hooks 40 may be included. As shown in FIGS. 5-7, the hooks 40 are located adjacent an aperture 45 such that the hooks 40 include a free end able to move between a compressed position and an extended position. More specifically, the apertures 45 disposed adjacent to the hooks 40 allow movement of the hooks 40 between the compressed and extended positions. In the extended position, the hooks 40 may extend laterally outward further than the remainder of the back panel engaging portion 49 and in the compressed position, the hooks 40 may be compressed towards the center of the wireless charging pocket 26.

Additionally, the back panel 28 may also include a plurality of indents 47 defined therein to receive the hooks 40 of the back panel engaging portion. The indents 47 of the back panel 28 are sized and shaped to engage the hooks 40 of the wireless charging pocket 26 to secure the wireless charging pocket 26 in the upper position, the lower position, or therebetween. The indents 27 may be arranged vertically and adjacent to both side portions 37 of the wireless charging pocket 26. For example, the indents 27 may be arranged on one or more vertical inner edges of the concave portion 29 of the back panel 28 and configured to receive the hooks 40 therein. Additionally, the plurality of indents 47 may be equally spaced from one another or otherwise arranged to secure the hooks 40 of the wireless charging pocket 26 to the back panel 28 at various positions. Moreover, the back panel 28 may include two vertical sets of indents 27 defined therein with the vertical sets disposed adjacent to each of the side portions 37 of the wireless charging pocket 26. However, other configurations have been contemplated including, but not limited to, a single vertical set of indents 27 or indents 27 that are disposed in a non-uniform manner (i.e., not equally spaced apart from one another).

For example, to assemble the wireless charging pocket to the vehicle seat 14, the hooks 40 of the back panel engaging portion 49 may begin in the fully extended position and during assembly, the hook 40 on one side portion 37 of the wireless charging pocket 26 will engage the indent 47 of the back panel 28 and compress into the fully compressed position. At this point, the hook 40 on the opposite side will be moved to the compressed positon to allow engagement with the indent 47 on the opposite side of the back panel 28 to secure the wireless charging pocket 26 to the back panel on both side portions 37. To remove the wireless charging pocket 26, hooks 40 on either side of the back panel engaging portion 49 may be moved to the compressed position and the wireless charging pocket 26 may be removed from engagement with the back panel 28.

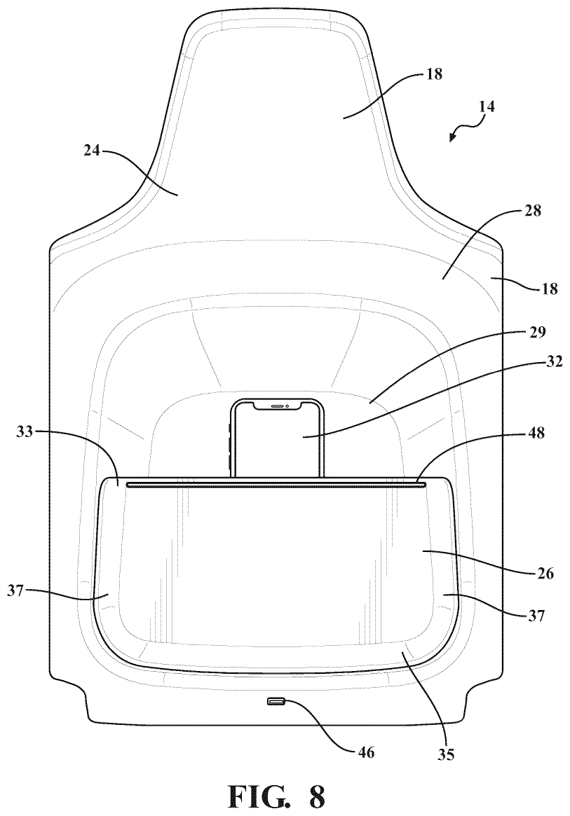

As best illustrated in FIG. 8, the rear portion 24 of the seat back portion 18 may also include a Universal Serial Bus (USB) port 46 configured to charge the user device 32, or a second user device, through wired charging. For example, the user device 32 may be charged through wireless charging using the wireless charging module 30 and a second user device may be charged simultaneously through the wired charging providing additional charging capabilities to the vehicle occupant.

As illustrated in FIG. 8, the wireless charging pocket 26 may include at least one illumination device 48 configured to provide notification that the user device 32 is being charged by the wireless charging module 30. For example, the illumination device 48 may remain off when the user device 32 is not being charged. If charging of the user device 32 is active, the illumination device 48 will illuminate to confirm to the vehicle occupant that charging is taking place. Additionally, the illumination device 48 may also be configured to change color to indicate a full charge of the user device 32. For example, when the user device 32 is currently being charged, the illumination device 48 may be illuminated in a red color. Once the user device 32 becomes fully charged, the illumination device 48 may illuminate in a green color to indicate full charge of the user device 32.

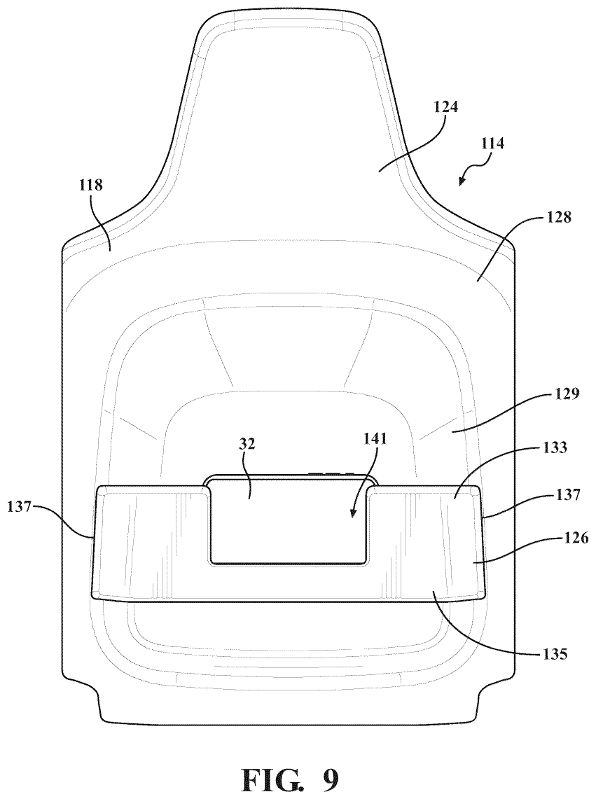

Referring now to the example shown in FIGS. 8 and 9, the wireless charging pocket 126 illustrated in FIGS. 8 and 9 is similar to the wireless charging pocket 26 illustrated in FIGS. 3A-7 such that the wireless charging pocket 126 includes the top portion 133, the bottom portion 135, and the side portions 137 comprised of a strong, flexible material and is configured to charge the user device 32 placed therein using the wireless charging module 30. Additionally, the wireless charging pocket 126 is moveable between the upper and lower positions and it configured to charge the user device 32 placed therein in any configuration. However, in the example shown in FIGS. 8 and 9, the wireless charging pocket 126 includes a cut-out portion 141 to facilitate viewing of the user device 32. The cut-out portion 141 is defined into the top portion 133 of the wireless charging pocket 126 and may be any size or shape or may be tailored to specific dimensions of commonly used user devices 32. Additionally, the flexible yet strong material of the wireless charging pocket 126 allows the user device 32 to be secured on either side of the cut-out portion within the wireless charging pocket 126 for charging with the display visible to the vehicle occupant. Additionally, in the example shown in FIGS. 8 and 9, the side portions 137 of the wireless charging pocket 126 may be shorter than the example shown in FIGS. 3-7 to allow for greater movement of the wireless charging pocket 126 between the upper position and the lower position.

In operation, the vehicle occupant may be seated behind a driver or front passenger seated in the vehicle seat 14. As such, the vehicle occupant is located in the rear of the vehicle interior 12 with the wireless charging pocket 26, 126 in the lower position and the illumination device 48 off. When desired, the vehicle occupant may secure the user device 32 in any configuration, such as one of the first configuration or the second configuration, by placing the user device 32 in the wireless charging pocket 26, 126. Once secure, the user device 32 is charged by the wireless charging module 30. The illumination device 48 may then illuminate and/or change colors to indicate the charging to the vehicle occupant. If desired, the vehicle occupant may then adjust the position of the wireless charging pocket 26, 126 between the lower position and the upper position to the desired viewing position for the vehicle occupant by engaging the wireless charging pocket 26, 126 and pulling or pushing the wireless charging pocket 26 up or down to the desired position. The force of the pulling or pushing the wireless charging pocket 26 disengages the hooks 40 from the indents of back panel 28 and slides the hooks 40 along the back panel 28 until the wireless charging pocket 26, 126 reaches the desired position where the hooks 40 may engage another indent corresponding with the desired position of the wireless charging pocket 26, 126 to secure the wireless charging pocket 26 in the desired position. The vehicle occupant then may view the display of the user device 32 as desired until charging is completed or otherwise desired by the vehicle occupant. To remove the user device 32, the vehicle occupant may open the wireless charging pocket 26, 126 and remove the user device 32.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle seat comprising:
a seat bottom; and
a seatback coupled to the seat bottom and including:
a front portion configured to oppose a vehicle occupant located on the seat bottom;
a rear portion disposed on an opposite side of the seatback than the front portion and including a pocket; and
a wireless charging module disposed between the front portion and the rear portion and configured to wirelessly charge a user device located in the pocket.

2. The vehicle seat of claim 1, wherein the pocket is configured to move between an upper position and a lower position relative to and along the rear portion.

3. The vehicle seat of claim 1, wherein the pocket is configured to move along a longitudinal axis between a first position and second position relative to the rear portion.

4. The vehicle seat of claim 1, wherein the pocket includes at least one illumination device configured to provide notification that the user device is being charged by the wireless charging module.

5. The vehicle seat of claim 4, wherein the illumination device is configured to change color to indicate a full charge of the user device.

6. The vehicle seat of claim 1, wherein the rear portion includes a Universal Serial Bus (USB) port configured to charge the user device through wired charging.

7. The vehicle seat of claim 1, wherein the user device is a cellular phone or a tablet.

8. A vehicle incorporating the vehicle seat of claim 1.

9. A vehicle seat comprising:
a seat bottom; and
a seatback coupled to the seat bottom and including:
a front portion configured to oppose a vehicle occupant located on the seat bottom; and
a rear portion disposed on an opposite side of the seatback than the front portion and including a pocket movable relative to the rear portion between a first position and a second position, the rear portion configured to receive and charge a user device when the pocket is in the first position and configured to receive and charge the user device when the pocket is in the second position.

10. The vehicle seat of claim 9, wherein the pocket is moveable along a longitudinal axis between the first position and the second position.

11. The vehicle seat of claim 10, wherein the pocket moves in a direction away from the seat bottom when moved from the first position to the second position.

12. The vehicle seat of claim 9, wherein the pocket includes at least one illumination device configured to provide notification that the user device is being charged.

13. The vehicle seat of claim 12, wherein the illumination device is configured to change color to indicate a full charge of the user device.

14. The vehicle seat of claim 9, wherein the rear portion includes a Universal Serial Bus (USB) port configured to charge the user device through wired charging.

15. The vehicle seat of claim 9, wherein the user device is a cellular phone or a tablet.

16. A vehicle incorporating the vehicle seat of claim 9.

17. A vehicle comprising:
a vehicle seat including:
a seat bottom; and
a seatback coupled to the seat bottom and including:
a front portion configured to oppose a vehicle occupant located on the seat bottom;
a rear portion disposed on an opposite side of the seatback than the front portion;
a pocket located on the rear portion and moveable relative to the rear portion between a first position and a second position; and
a wireless charging module disposed between the front portion and the rear portion and configured to wirelessly charge a user device located in the pocket, the wireless charging module configured to charge the user device when the pocket is in the first position and configured to charge the user device when the pocket is in the second position.

18. The vehicle of claim 17, wherein the pocket is moveable along a longitudinal axis between the first position and the second position.

19. The vehicle of claim 17, wherein the pocket moves in a direction away from the seat bottom when moved from the first position to the second position.

20. The vehicle seat of claim 17, wherein the user device is a cellular phone or a tablet.
